(19) United States
(12) Patent Application Publication
(10) Pub. No.: US 2008/0011821 A1
(43) Pub. Date: Jan. 17, 2008

(54) Method and System of Determining Orifice Plate Parameters

(75) Inventors: Damon J. Ellender, Loftus (AU); Duane B. Toavs, Taylor, TX (US)

Correspondence Address: CONLEY ROSE, P.C.;David A. Rose, P. O. BOX 3267, HOUSTON, TX, 77253-3267, US

(73) Assignee: DANIEL MEASUREMENT AND CONTROL, INC., Houston, TX (US)

(21) Appl. No.: 11/774,727

(22) Filed: Jul. 9, 2007

Related U.S. Application Data
(60) Provisional application No. 60/806,852, filed on Jul. 10, 2006.

(51) Int. Cl. G06F 17/00; G08B 13/14; G08B 21/00

(52) U.S. Cl. 235/375; 340/572.1; 340/686.1

(57) ABSTRACT

A method and system of determining orifice plate parameters. At least some of the illustrative embodiments are methods comprising installing an orifice plate in a metering tube, and reading parameters of the orifice plate by a flow computer. In some embodiments, the orifice plate comprises a radio frequency identification (RFID) tag, and a flow computer responsible for calculating flow rate and volume reads the RFID tag to determine parameters of the orifice plate, such as aperture diameter.

### CROSS-REFERENCE TO RELATED APPLICATIONS

This application claims the benefit of provisional application Ser. No. 60/806,852, filed Jul. 10, 2006, and entitled “Method And System Of Determining Orifice Plate Parameters”, which application is incorporated by reference herein as if reproduced in full below.

### BACKGROUND

The flow volume of fluids (e.g., natural gas) is in some circumstances measured using an orifice plate disposed within the fluid flow. As the fluid traverse the orifice plate, a pressure drop occurs and the magnitude of the pressure drop is proportional to the fluid flow. More particularly, the magnitude of the pressure drop is a function of the flow rate of the fluid and the aperture diameter of the orifice plate. Thus, in order to correctly measure the flow volume, knowledge of the aperture diameter is desirable. In some systems, the aperture diameter and possibly other parameters are entered into a flow computer by way of a key pad after each installation of a new orifice plate. Errors and/or omission regarding the orifice plate parameters lead to miscalculation of flow volume.

### BRIEF DESCRIPTION OF THE DRAWINGS

For a detailed description of the various embodiments of the invention, reference will now be made to the accompanying drawings in which:

FIG. 1 shows a system in accordance with some embodiments;

FIG. 2 shows an orifice plate in accordance with some embodiments;

FIG. 3 shows the orifice plate of FIG. 2 with a reader coupled thereto in accordance with at least some embodiments;

FIG. 4 shows an orifice plate in accordance with some embodiments;

FIG. 5 shows an orifice plate in accordance with some embodiments;

FIG. 6 shows a perspective view of an orifice fitting and orifice plate in accordance with some embodiments;

FIG. 7 shows an elevational cut-away view of an orifice fitting in accordance with some embodiments;

FIG. 8 shows an electrical block diagram of a flow computer in accordance with some embodiments; and

FIG. 9 shows an illustrative method in accordance with some embodiments.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

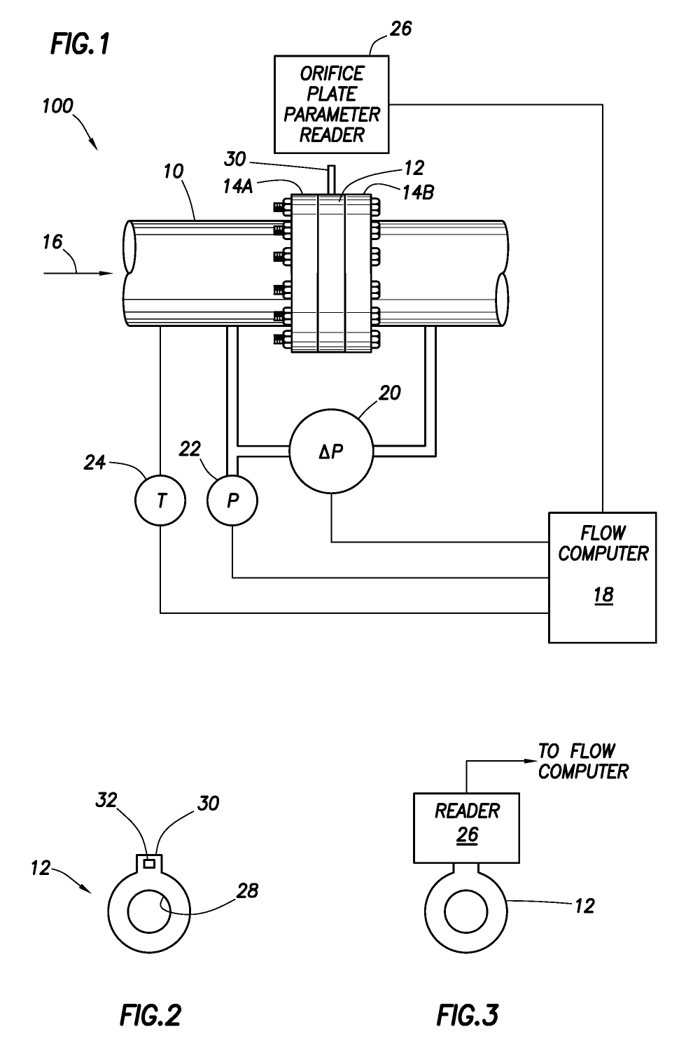

FIG. 1 illustrates a system 100 in accordance with at least some embodiments. In particular, the system 100 comprises a metering tube 10 within which an orifice plate 12 is disposed. In the illustrative system of FIG. 1, the orifice plate 12 is held in place by a set of flanges 14; however, other systems for holding the orifice within the metering tube 10 may be equivalently used (e.g., Daniel SENIOR® Orifice Fitting available for Emerson Process Management of St. Louis, Mo.). Fluid may flow through the metering tube 10 in the direction indicated by arrow 16, which fluid flow causes a pressure drop across the orifice plate 12.

In order to measure the instantaneous flow rate and to accumulate flow volume over time, system 100 comprises a flow computer 18 coupled to various temperature and pressure measurement devices. In particular, flow computer 18 electrically couples to a delta-pressure (delta-P) transmitter 20, upstream pressure transmitter 22, and in some cases upstream temperature transmitter 24. The delta-P transmitter 20 fluidly couples upstream of the orifice 12 and downstream of the orifice 12, and provides to the flow computer 18 an indication of the pressure differential across the orifice plate caused by the flow of fluids. Pressure transmitter 22 fluidly couples upstream of the orifice plate 12 and provides to the flow computer 19 an indication of the upstream pressure. Likewise, temperature transmitter 24 measures temperature upstream of the orifice plate and provides the temperature to the flow computer 18. Using the measured pressure across the orifice plate, upstream pressure and in some cases upstream temperature, the flow computer 18: calculates an instantaneous flow rate of fluid through the metering tube 10; and accumulates or integrates the instantaneous flow rate to calculate the volume flow of fluids over time.

In accordance with at least some embodiments, various parameters associated with the orifice plate (e.g., aperture diameter, plate thickness, and the like) are read by the flow computer 18, and thus need not be provided by the installer of the orifice plate 12. In particular, flow computer 18 electrically couples to an orifice plate parameter device or reader 26. The flow computer 18 reads orifice plate parameters using the orifice plate parameter reader 26.

In at least some embodiments, a radio frequency identification (RFID) tag is coupled to the orifice place and contains the orifice plate parameters, with the orifice plate parameter reader 26 being a RFID reader. FIG. 2 illustrates orifice plate 12 in accordance with some embodiments using a RFID tag. In particular, orifice plate 12 comprises an aperture 28 through which fluids flow. The orifice plate 12 also comprises a tab 30 (which is also visible in FIG. 1). A RFID tag 32 is coupled to the tab 30.

There are several types of RFID tags operable with the various embodiments. For example, RFID tags may be active tags, meaning each RFID tag comprises its own internal battery or other power source. Using power from the internal power source, an active RFID tag monitors for signals from the RFID reader. When an interrogating signal directed to the RFID tag is sensed, the tag response may be tag-radiated radio frequency (RF) power using power from the internal battery or power source. A semi-active tag may likewise have its own internal battery or power source, but a semi-active tag remains dormant (i.e., powered-off or in a low power state) most of the time. When an antenna of a semi-active tag receives an interrogating signal, the power received is used to wake or activate the semi-active tag, and a response (if any) comprising an identification value is sent by modulating the RF backscatter from the tag antenna, with the semi-active tag using power for internal operations from its internal battery or power source. In particular, the RFID reader continues to transmit power after the RFID tag is awake. While the RFID reader transmits, an antenna of the RFID tag is selectively tuned and de-tuned with respect to the carrier frequency. When tuned, significant incident power is absorbed by the tag antenna. When de-tuned, significant power is reflected by the tag antenna to the RFID reader. The data or identification value modulates the carrier to form the reflected or backscattered electromagnetic wave. The RFID reader reads the data or identification value from the backscattered electromagnetic waves.

A third type of RFID tag is a passive tag, which, unlike active and semi-active RFID tags, has no internal battery or power source. The tag antenna of the passive RFID tag receives an interrogating signal from the RFID reader, and the power extracted from the received interrogating signal is used to power the tag. Once powered or “awake,” the passive RFID tag may accept a command, send a response comprising a data or identification value, or both; however, like the semi-active tag the passive tag sends the response in the form of RF backscatter. RFID tags and readers are commercially available from many sources, such as RFID, Inc. of Denver, Colo.

Still referring to FIG. 2, in accordance with at least some embodiments the RFID tag 32 stores parameters of the orifice plate (e.g., aperture diameter, orifice plate thickness, and the like). When queried by an RFID reader, such as the orifice plate parameter reader 26 of FIG. 1, the RFID tag transmits an electromagnetic wave to the reader 26 with the parameters of interest. Those parameters, in turn, are provided to the flow computer 18 and used in calculating instantaneous fluid flow and flow volume.

The reader 26 is placed proximate to the RFID tag 32. For example, the reader 26 may be mechanically coupled to the metering tube 10 or flanges 14 such that the reader is physically close to the RFID tag 32. In other embodiments, the reader 26 is configured to have a slot that enables the reader 26 to slide over and thus couple to the tab 30, as illustrated in FIG. 3. In any case, the reader 26 is positioned proximate to the RFID tag 32 on the tab 30 such that parameters of the orifice plate may be read.

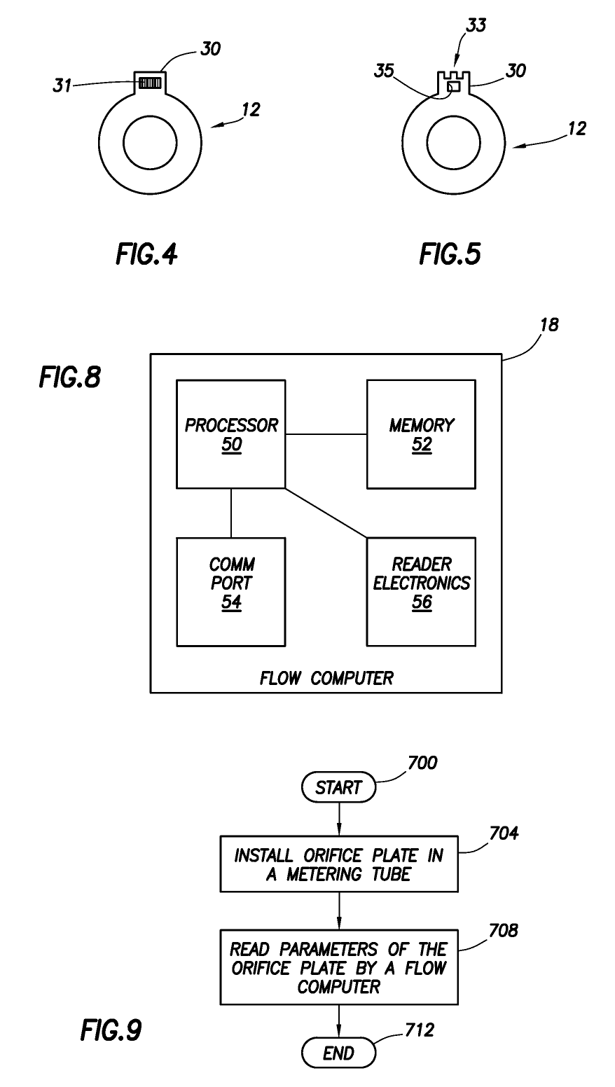

In yet still other embodiments, the orifice plate parameter reader 26 reads parameters of the orifice plate by other mechanisms. For example, FIG. 4 illustrates embodiments where the tab 30 of the orifice plate 12 comprises a bar code 31. In these embodiments, the bar code 31 encodes the orifice plate parameters. In the case of the bar code, the orifice plate parameter reader 26 comprises a laser scanner to read the bar code. FIG. 5 illustrates yet still other embodiments where the tab 30 of the orifice plate 12 comprises notches 33. In these embodiments, the notches 33 and/or aperture 35 that encode the orifice plate parameters. For example, the notches/aperture may define Boolean values that correspond to predetermined plate parameters, or the features themselves (e.g., number of notches/aperture, distance between the notches/apertures, width/depth of the notches/apertures, number of apertures and notechs) directly encode the parameters of interest. In the case of notches and/or apertures in the plate, the orifice plate parameter reader 26 comprises light emitting diodes and optical receiver pairs to determine the presence and/or width of the notches 33 and/or apertures 35. In yet still other embodiments, the orifice late parameter reader 26 reads the parameters by optical character recognition. In particular, the parameters of interest may be placed in character form on the orifice plate 12 (e.g., on the tab 30). The parameter reader 26 in these embodiments comprises an optical system to “see” the characters and convert the characters to digital values.

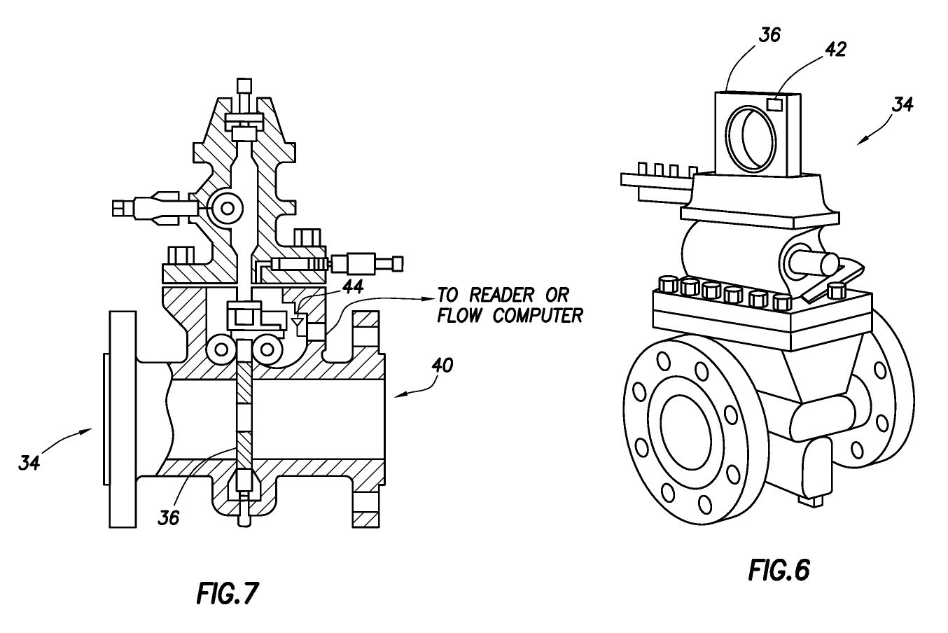

The various embodiments discussed to this point have been in relation to systems where the orifice plate is held in place between two flanges; however, other systems enable the orifice plate to be installed and removed without unbolting one or more flanges. One such system that allows installation and removal is the Daniel SENIOR Orifice Fitting mentioned above. FIG. 6 illustrates a perspective view of a SENIOR orifice fitting 34 in accordance with some embodiments. In particular, the SENIOR orifice fitting 34 enables a technician to install and remove a specially designed orifice plate 36 into a metering tube (not specifically shown in FIG. 6) without unbolting one more flanges of the metering tube. The orifice plate 36 is forced from the top of the orifice fitting 34 (as illustrated) into the fluid flow by a rack and pinion engagement, with the rack being on the orifice plate 36, and the pinion turned by an external handle.

FIG. 7 shows a partial cross-sectional elevational view of the orifice fitting 34 with the orifice plate 36 in place in the fluid flow. As shown, the orifice fitting 34 defines an internal volume 40, and it is within the internal volume 40 that the orifice plate 36 resides when in operation. Referring simultaneously to FIGS. 6 and 7, in accordance with at least some embodiments the orifice place 36 comprises an identification device or feature 42. Likewise, the orifice fitting 34 comprises a reader at least partially disposed within the body of the orifice fitting 34, such as reader 44. In some embodiments, only a portion of the reader 44 may reside within the orifice fitter (e.g., an antenna for reading RFID tags, a laser for reading bar codes or LED/sensor pairs for reading notches or apertures). In other embodiments, the entire reader system may reside within the body of the orifice fitting 34. The reader 44 enable reading of the identification device 42 of the orifice plate 36 during installation and/or once the orifice plate 36 is fully installed. Much like the previously discussed embodiments, the identification feature 42 (e.g., a RFID tag, a bar code, a notch/aperture, optically recognizable characters) comprises or indicates parameters of the orifice place 36 used by the flow computer in calculating instantaneous flow rate and flow volume over time.

FIG. 8 is an electrical block diagram of a flow computer 18 in accordance with at least some embodiments. In particular, the flow computer 18 comprises a processor 50 coupled to a memory 52. The memory 52 may comprise a read-only memory that stores programs accessed and executed by the processor 50, and the memory 52 may also comprise random access memory. Executing programs stored in the memory 52, the processor 50 is configured to calculate instantaneous flow rate through a meter run comprising an orifice plate, and also to calculate flow volume over time. In some embodiments the processor 50 couples to a communication port 54. The communication port 54 couples to electronics for a reader (e.g., an RFID tag reader), and thus the processor may read parameters of an orifice plate and calculate flow and volume using the parameters read. In alternative embodiments, the reader electronics may be internal to the flow computer 18, such as reader electronics 56 coupled to the processor 50. In embodiments where the reader electronics are internal to the flow computer, the reader electronics 56 may couple to a reading system proximate to the orifice plate (e.g., antenna to read RFID tags, or an optical device configured to read features such as bar codes, apertures/notches or optical characters).

FIG. 9 illustrates a method in accordance with at least some embodiments. In particular, the method starts (block 700) and proceeds to installing an orifice plate in a metering tube (block 704). Installing may illustratively comprise bolting an orifice plate between two flanges (as illustrated in FIG. 1), running the orifice plate into an orifice fitting by way of a rack and pinion system (FIGS. 6 and 7), or any other currently existing or after-developed mechanism for placing an orifice plate in a metering tube. Thereafter, parameters of the orifice plate are read by a flow computer (block 708), and the process ends (block 712). Reading the parameters of the orifice plate may take many forms. In some embodiments, the orifice plate has an RFID tag mounted thereon. The flow computer reads the parameters of the orifice plate by reading the RFID tag. In other embodiments, the orifice plate has a bar code attached thereto. The flow computer reads the parameters of the orifice plate by reading the bar code. In yet still other embodiments, the orifice plate has a one or more notches and/or apertures. In yet still other embodiments, the orifice plate may comprise optically readable characters. In some embodiments, the identification feature may be mounted on a tab 30 of the orifice plate (FIG. 1) and read by reader 26 proximate to the tab 30. In other embodiments, the identification feature is mounted on the orifice plate and is read by a reader at least partially within the body of an orifice fitting 34.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
installing an orifice plate in a metering tube; and
reading parameters of the orifice plate by a flow computer.

2. The method according to claim 1 wherein reading further comprises at least one selected from the group consisting of: reading a radio frequency identification tag coupled to the orifice plate; reading a bar code coupled to the orifice plate; determining the presence of one or more notches on the orifice plate; determining the presence of one or more apertures through the orifice plate; and optically reading characters disposed on the orifice plate.

3. The method according to claim 1 further comprising:
wherein installing further comprises installing the orifice plate between two flanges of the metering tube, the orifice plate having a tab that extends beyond the outside diameter of the flanges; and
wherein reading further comprises reading the parameters from the tab.

4. The method according to claim 3 wherein reading further comprises reading by way of a reading device placed proximate to the tab.

5. The method according to claim 3 wherein reading further comprises placing a reading device over the tab.

6. The method according to claim 1 further comprising:
wherein installing further comprises installing the orifice plate within a meter body; and
wherein reading further comprises reading the parameters while the orifice plate is at least partially within the meter body.

7. An orifice plate comprising:
an orifice plate body;
an aperture through the orifice plate body through which a metered fluid flows;
an identification device coupled to the orifice plate body, the identification device configured to be electronically readable and to identify at least one selected from the group: metering aperture diameter; orifice plate body thickness; and beveling of the edges of the aperture.

8. The orifice plate according to claim 7 further comprising a tab extending from the orifice plate body, wherein the parameter identification system is associated with the tab.

9. The orifice plate according to claim 7 wherein the orifice plate body further comprises a linear set of teeth configured to crank the orifice plate into a meter body.

10. The orifice plate according to claim 7 wherein the identification device further comprises at least one selected from the group consisting of: a radio frequency identification (RFID) tag; a bar code; a notch; and an aperture.

11. A system comprising:
a meter body having an internal volume, the internal volume configured to accept an orifice plate;
a reading device disposed at least partially within the internal volume and configured to read parameters of the orifice plate when the orifice plate is within the internal volume.

12. The system according to claim 11 wherein the reading device further comprises an antenna of a radio frequency identification (RFID) tag reader.

13. The system according to claim 11 where the reading device further comprises a light source.

14. The system according to claim 13 wherein the reading device further comprises a laser configured to read a bar code on the orifice plate.

15. The system according to claim 13 wherein the reading device further comprises an optical source configured to determine the presence or absence of features of the orifice plate.

16. The system according to claim 13 wherein the reading device further comprises an optical source configured to perform optical character recognition.

17. A flow computer comprising:
a processor;
a memory coupled to the processor;
a communication port coupled to the processor;
wherein the processor is configured to calculate flow through a meter run comprising an orifice plate; and
wherein the processor is configured to read parameters of the orifice plate through the communication port, and use the parameters read to calculate flow through the meter run.

18. The flow computer according to claim 17 wherein the communication port couples to a radio frequency identification (RFID) tag reader, and wherein the processor is configured read parameters of the orifice plate comprising an RFID tag, the reading through the communication port.

19. The flow computer according to claim 17 wherein the communication port couples to an optical reader, and wherein the processor is configured read parameters of the orifice plate through the optical reader, the reading through the communication port.

20. A flow computer comprising:
a processor;
a memory coupled to the processor; and
reader electronics coupled to the processor, the reader electronics configured to couple a reading system proximate to a orifice plate;
wherein the processor is configured to read parameters of the orifice plate using the reader electronics, and the processor is configured use the parameters read to calculate flow through the orifice plate.

21. The flow computer according to claim 20 wherein the reading system further comprises an antenna proximate configured to be placed proximate to a radio frequency identification (RFID) tag associated with the orifice plate.

22. The flow computer according to claim 20 wherein the reading system further comprises an optical reading system configured to be placed proximate to the orifice plate.
